(19) United States
(12) Patent Application Publication
(10) Pub. No.: US 2008/0303717 A1
(43) Pub. Date: Dec. 11, 2008

(54) Oblique EM wave navigation coordinate plotter and cooperative transponder

(76) Inventors: Jack P. Durban, (US); Nicholas J. Yocca, (US)

Correspondence Address: JOHN P. DURBAN, 22371 SUNBROOK, MISSION VIEJO, CA, 92692, US

(21) Appl. No.: 12/154,628

(22) Filed: May 23, 2008

Related U.S. Application Data
(60) Provisional application No. 60/931,356, filed on May 23, 2007.

(51) Int. Cl. H01Q 3/00

(52) U.S. Cl. 342/371

(57) ABSTRACT

A high speed obliquely disposed EM “Electromagnetic Wave” based image plotter consisting of one or more narrow beam EM radiators conveying trigonometrically derived location coordinates to one or more cooperative EM pixel decoding tags, transponders or like circuitry. The cooperative transponder detects and decodes the EM pixels and reconciles its own location from resident memory stored navigation map that is changeable by the EM plotter. The EM plotter is obliquely oriented in relation to the operative navigation space it covers as to establish a three point trigonometric relationship between the plotter's fixed elevation to its cooperative transponder's X axis distance from the plotter as determined by the elevation angle of the plotter's beacon at the time of measurement.

The EM Plotter projects one or more beacons in the form of a continuous non-overlapping and repeating Archimedean or arithmetic spiral or other predetermined pattern containing EM navigation location pixels.

### CROSS REFERENCES TO RELATED APPLICATIONS

This application claims the full benefit and priority of U.S. Provisional Application Ser. No. 60/931,356, filed on May 23, 2007, the disclosure of which is fully incorporated by reference herein for all purposes.

### BACKGROUND

1. Field of the Invention

The present disclosure relates generally to a new and novel navigation and localization system capable of electromagnetically projecting precise localization coordinates and heading data to a cooperative transponder from a single terrestrial or non-terrestrial point of origin steered beacon. Still more particularly, the present invention relates to an obliquely disposed multi axis scanning beacon conveying navigation, localization and dead reckoning heading determination for terrestrial or non-terrestrial vehicles, agents, aircraft, badges, and other transponder attachable objects.

2. Description of the Related Art

Various navigation and localization approaches have been considered and or deployed over the years in an effort to provide navigational or contextual location awareness of persons, agents, objects, aircraft and livestock. These methodologies primarily relied upon the cooperative exchange of data between multiple fixed position interrogators, readers, sign posts or other beacons and mobile asset affixed tags, personnel worn badges, and other portable communicative devices. To accommodate communications between these devices designers experimented with various Sonar, and R.F. radiators and each approach revealed serious shortcomings. Sonar produced beacons that were difficult to focus and in outdoor applications had to be wind and noise compensated. The use of conventional R.F. carriers were very problematic insomuch as the carriers are subject to propagation phenomena like absorption, reflection, multi-path, and other performance hindering phenomena. Some of these devices rely upon RSSI or “Relative Signal Strength Indication” as a measure of proximity between a stationary beacon and a mobile tag. The problem with this approach is that RSSI is not a reliable indicator of proximity as it is also subject to propagation errors. More advanced approaches like TOF “Time of Flight” use a plurality of time synchronized cooperative interrogator/readers to triangulate or “trilateralize” a mobile transmitting tag or other electronic device within a known area of travel.

Such conventional localization Mechanisms can be categorized into four groups, “Active” where the system sends signals to localize a target transponder, “Cooperative” where the target transponder cooperates with the system, “Passive” where the system relies upon already present signals, and “Blind” where the system deduces transponder location without prior knowledge of its characteristics. The instant invention falls into the “cooperative infrastructure” producing a navigational location signal intended to be received and decoded by a cooperative mobile tag, transponder or like circuit residing within or attached to a host object or worn by a person or animal. The subject transponder may be a receiver or transceiver depending upon the application.

The unauthorized removal of wheeled assets like Shopping Carts and other human propelled carts from merchants, hospitals, and other enterprises is well known. The amount of financial loss globally, from shopping carts and wheel chairs alone exceed half a billion dollars annually. Over the last decade or so there have been many attempted solutions to address this problem. The localization and navigation of shopping carts and the shopping behavior of patrons who use them is of great import to merchants and those who provide goods for sale by merchants.

Accordingly, U.S. Pat. No. 4,772,880 to Goldstein discloses a shopping cart containment method that relies upon a radio receiver inside the lockable wheel detecting when the cart has traveled outside a predetermined electromagnetic field created by a corresponding transmitter and antenna. This is known in the art as an umbilical type device that creates a predetermined safe area of operation between an interrogator and a corresponding transponder. When this distance is exceeded one or both of the cooperative devices sounds an alarm or alert. The use of an electromagnetic or R.F. field or radiation based range area is fraught with pitfalls in attempting to create a predictable coverage area due to the inherent nonsymmetrical nature of Electromagnetic radiation displaced by one or more antennas used in this configuration. The range determining area of electromagnetic radiation would be severely influenced by propagation variables like dispersion multi-path, shadowing, and reflections from fixed and moving objects like metallic vehicles and other electromagnetically absorptive or reflective barriers that contribute to undesirable operation.

U.S. Pat. No. 5,357,182 to Wolfe discloses a dual loop perimeter antenna based cart containment system that is based on an inner and outer wired loop displaced about the perimeter of a predetermined area of authorized shopping cart usage. The outer and inner loops provide a lock and unlock signal command each respectively. The disclosed means of inhibiting the cart is a chain driven motor used as a dynamic brake when its terminals are shorted together. The use of a chain driven motor as a braking scheme in this type of application is impractical due to cost, exposure to the elements, regular lubrication of a chain, and the considerable drag that the motor would burden the cart with in its unlocked or normal operating state. The cost to trench a parking lot to bury and seal a signal wire loop wire is very expensive. The cost to bury two loops as disclosed would be so prohibitive that the installation costs alone would make the solution impractical.

U.S. Pat. No. 5,576,691 to Coakley et al discloses a locking wheel that relies upon a preprogrammed distance in its memory to determine that it has traveled outside a store parking lot. A static or fixed measurement of distance used as a reference to establish a barrier of predetermined area of authorized shopping cart usage does not take into effect several variables that would reflect human behavior like getting lost in a parking lot searching for their vehicle. Even if the worst case distance is used as a means of establishing a perimeter there is the chance that the patron could exit at a less than worst cast distance, resulting in the permitted distance stored in memory to be reached somewhere of the store property, maybe in the middle of a busy intersection crosswalk.

U.S. Pat. No. 5,831,530 to Lace et al discloses a locking wheel that relies upon a predetermined VLF (Very Low Frequency) signal emanating from a perimeter establishing buried wire loop in a retail parking lot. The wheel contains a circuit to detect the presence of the predetermined signal and hard locks the wheel using a brake band. The predetermined carrier detection scheme uses a resonant tank circuit to reject out of band frequencies and to pass the intended predetermined 8 kilohertz carrier. The use of a VLF resonant tank circuit at this low of a frequency requires an inductor that is so high in value that it is susceptible to being overloaded or saturated by a DC magnetic field like that produced by a small inexpensive magnet. Being able to circumvent the locking of the cart with such a readily available object is undesirable. The Braking mechanism by its nature will lock the wheel hard. If the user pushing the cart were unaware of the pending hard lock up of the cart, he or she could be injured posing a risk of liability to the cart's owner, the retailer. To unlock or reset the wheel in an effort to return the cart to normal operation, the locked cart must be dragged several feet away from the influence of the intentional signal carrier emanating from the loop it is captured upon or near. Once the locked cart is far enough away from the loop it can be unlocked with a hand held device. The need to have to drag a disabled cart that can't roll for several feet can cause injury to store personnel which can become a worker's compensation claim or worse. Because the locking wheel is opaque and all of its components are internal to the wheel there is no visible means of the wheel's state of disposition. A potential user of the subject cart can't tell if it is locked or broken creating confusion and frustration. The nature of this device also requires complete disassembly of the caster to make a customary battery change precluding store personnel from being able address this simple ongoing maintenance item.

U.S. Pat. No. 5,881,846 to French et al discloses a wheel that is disabled by a spring loaded shell that when activated by the same VLF perimeter signal method as disclosed in the Lace patent encompasses the lower portion or ground contacting half of the wheel. The shell's inherent resistance to sliding on some surfaces like concrete and asphalt make the cart difficult to navigate. Once the shell encompasses the cart's wheel it can only be reset after dragging the immobilized cart several feet away from the loop signal. Then, once a hand held remote control device electronically allows the shell to be retracted the store employee, by hand, elevating the cart and while the shell is not contacting the ground must reload the spring activated shell back into its standby state. This is a lot of effort and risk of injury just to free the cart for re-use. The external shell as it deploys inherently acts as a scoop to loose debris and snow making it susceptible to failure.

U.S. Pat. Application No. US 2006/0247847 to Carter et al discloses a wireless shopping cart containment system reliant upon a network of static or DC magnet based markers and fixed geometry R.F. created markers to aid in creating a navigational map of a operational perimeter. First a survey must be conducted to create a digitized map of the store property. From this map an area of allowable operation and other coordinates can be created. To detect, interpret and act upon the presence of these markers an in-wheel AMR “Anisotropic magneto resistance magnetic field sensor like those used in digital compassing is deployed. The intended function of this system relies upon compassing and distance as provided by a wheel rotation counter to arrive at direction and distance data that can be used to provide real time location of a fleet of shopping carts within a network.

The use of a magnetic sensor to determine heading in an environment like a shopping center inside a shopping cart wheel is nearly impossible due to stray magnetic fields from soft and hard irons found throughout such an environment. The use of heading calibrating markers like those taught in US 2006/0247847 will only provide marginal improvements to heading data accuracy as accumulated dead reckoning errors will be so great that an impractical amount of these markers would be necessary to maintain enough navigational accuracy to be of any use within such an application.

Another technological shortcoming taught in US 2006/0247847 is the deployment of R.F. radiators to provide proximity measurements of a shopping cart by use of RSSI or “Relative Signal Strength Indication”. This concept is well known in the art to be incapable of providing reliable correlation between signal strength to distance due to propagation induced errors and other error contributive factors.

Another technological shortcoming taught in US 2006/0247847 is the deployment of DC magnets about the property to provide navigation calibration. It is well known that over time magnets lose their strength and will become less detectable over time and temperature. Also magnets can attract ferrous debris like iron ore particulates and every day items like paper clips, nails, and other like materials.

The prior art heretofore known suffer from a number of disadvantages.
(a) Cart Containment methods that disclose defining an area of permitted Shopping Cart use by fixed or preprogrammed travel distances as a measure of maximum permitted cart travel prior to cart immobilization can put the user at risk of being immobilized in traffic lanes of the store parking lot or surrounding streets.
(b) Cart Containment methods that disclose an area of permitted Shopping Cart use by blanketing the permitted area with an R.F. carrier fail to address the unpredictable nature of electromagnetic radiation bode plots and associated environmental impacts on signal strength and pattern. Like the fixed counter based methodologies, can put the user at risk of being immobilized in traffic lanes of the store parking lot or surrounding streets.
(c) Cart Containment methods that disclose the use of VLF tuned tank circuits for receiver selectivity are easily circumvented by a magnet placed proximate the locking wheel while traversing the VLF radiating perimeter loop.
(d) Cart Containment methods that disclose the use of buried or suspended hard wired perimeter loops are very costly to install due to requisite asphalt saw cutting, loop wire burial, and sealing the loop with tar or other weather/tamper resistant materials.
(e) Cart Containment methods that disclose the use of buried or suspended hard wired perimeter loops create a burden and risk of injury to personnel and patrons during the installation process which involves heavy equipment like saw cutters and welding equipment often during store operating hours.
(f) Cart Containment methods that disclose the need to drag their locked cart away from the influence of the VLF Perimeter loop predetermined signal to introduce an unlock signal from a VLF transmitting hand held device put store personnel at risk of injury in having to drag a heavy destabilized load for several feet.
(g) Cart Containment methods that disclose digitally mapped coordinate navigation technology relying upon faulty magnetic dead reckoning requiring DC magnet and or R.F. created markers to tune or calibrate itself
It is therefore apparent that there is a need for a new and novel means of improving asset tracking and localization of motion, objects, wireless devices and users, persons and animals.

### SUMMARY OF THE INVENTION

A highly integrated navigation and localization system consisting of one or more obliquely oriented multi-axis EM Wave Plotters broadcasting location coordinate navigation patterns into a space above ground level where corresponding EM detecting and decoding transponder equipped wheeled vehicles or objects navigate in a space be terrestrial or extra-terrestrial.

In one embodiment consisting of a mobile system, internal sensors like accelerometers, gyros, and other devices to compensate for pitch, roll, yaw, altitude, acceleration and any other error conditions that may skew self localization and the orientation of the EM plotter and or EM pixel beacons.

In another preferred embodiment a corresponding transponder may be an autonomous tag like device may be carried about by a person, animal, or object. As the EM transponder intercepts EM pixels within EM navigation zones it decodes the EM pixel's imbedded location coordinate and using an internal digital map determines its location. Other information may be contained within the same or EM pixel like a time and date stamp, housekeeping, firmware upgrades, etc. The transponder may report periodically, randomly, or by some predetermined distance, event, change in state, condition, or elapsed period time. Dead reckoning heading data is inherently provided by simple computation between each location coordinate update. The transponder or wheeled vehicle may locally maintain in memory, a digital map of one or more navigation boundaries. This digital map is dynamically created and assigned by the EM Plotter, hand held device, network, or similar means.

In one of many preferred embodiments the instant invention is ideally suited to provide navigation and localization for shopping carts or trolleys as they are often referred to as outside the U.S. The utility realized in this embodiment is the real time navigational mapping provided to shopping carts outfitted with a corresponding imbedded EM detector decoder circuit. Such an application would provide real time location of carts inside and outside the store allowing store personnel to quickly locate shopping cart inventories and determine when a cart roundup is practical or essential.

In a similar preferred embodiment the instant invention is ideally suited to provide real time location of shopping carts outfitted with shopper display terminals to let shoppers know where store items are located and provide shopping cart navigation pattern data to retailers and manufacturers.

In another similar preferred embodiment the instant invention provides real time location of shopping carts outfitted with security devices like locking wheels and other forms of disabling the carts when they reach a predetermined boundary like the perimeter of a retail shopping center parking lot. The current state of the art in shopping cart containment (locking shopping carts) is to immobilize a cart when it reaches a boundary consisting of a buried parking lot perimeter wire emitting a VLF “Very Low Frequency” detectable carrier that is OOK “On Off Keyed” modulated with a “Lock” command. As long as the immobilized cart is within the influence of the lock signal it cannot be unlocked which is accomplished by use of a hand held low power remote control emitting an “unlock” command.

The instant invention would not require such a device to free the decommissioned cart. To return an immobilized cart to full service it would simply be a matter of pointing the cart in a direction toward the interior of the parking lot and traveling just a short distance to intercept and receive just one coordinate point.

In another similar preferred embodiment the instant invention provides real time location of shopping carts outfitted with security devices like locking wheels and other forms of disabling the carts if they attempt to exit the store without first paying for merchandise, an act known as “push out” in the loss prevention industry.

In another preferred embodiment the instant invention is ideally suited to provide real time location and containment of pets both indoors and outdoors. Pet travel indoors could be limited by zones within the home. Expensive furniture could be mapped as a “restricted zone” and attempted excursion into the zone would result in an audible tone or mild shock from the pet's collar.

In a similar preferred embodiment the instant invention is ideally suited to provide real time location, containment and segregation of livestock. In the management of cattle in open pasture, fertile cows and bulls can share the same grazing space by using shock collar technology to maintain a predetermined boundary between them.

In a similar preferred embodiment the instant invention is ideally suited to provide real time location, segregation of persons by sex in schools where commingling is not accepted during times like recess, lunch, and events.

In a similar preferred embodiment the instant invention is ideally suited to provide real time location, segregation of persons by risk factors pertaining to health, biohazard, etc.

In another preferred embodiment the instant invention is ideally suited to provide real time location, containment and segregation of tagged persons, objects, or other transponder equipped items in dynamically assigned zones that can be modified in size, shape, or purpose.

In another preferred embodiment the instant invention is ideally suited for advanced indoor navigation applications where the instant invention plots patterns of high resolution EM pixels onto surfaces, walls, ceilings, and objects to provide an ideal navigation system for agents like autonomous floor cleaners like the Roomba (Protected name) and toy robots. The EM images could consist of infrared bar codes or other easily image read indicia.

In another preferred embodiment the instant invention is ideally suited for advanced security applications where the instant invention plots patterns of high resolution EM pixels onto surfaces, walls, ceilings, objects or near space and a corresponding imager looks for and alarms upon any scene change that would be indicative of intrusion.

In another preferred embodiment the instant invention is ideally suited for local temporary air traffic navigation primarily for RC “Remote Control” aircraft. In this embodiment the EM plotter is inverted upside down and plots EM pixels in a predetermined pattern where the corresponding transponder equipped aircraft will be flying. RC aircraft must be very light in weight and the present invention could provide flight data that would normally be provided by onboard systems that would add undesirable weight. Such data includes but is not limited to altitude, air speed, and of course coordinate location and heading.

The zonal containment of canines within a residential property is primarily accomplished using a buried perimeter prescribing wire loop that emits a detectable low frequency carrier that is received by the pet's collar worn receiver when within range or proximate to the loop. The installation of this subterranean loop and driver is time consuming, laborious and beyond the abilities of a large segment of the buying public.

The zonal containment of the infirmed or children or a child's ride on toy within a residential or day care property could prevent an unsafe event.

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

A “patentable” composition, process, machine, or article of manufacture according to the invention means that the subject matter satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically exclude the unpatentable embodiment(s). Also, the claims appended hereto are to be interpreted both to provide the broadest reasonable scope, as well as to preserve their validity. Furthermore, if one or more of the statutory requirements for patentability are amended or if the standards change for assessing whether a particular statutory requirement for patentability is satisfied from the time this application is filed or issues as a patent to a time the validity of one or more of the appended claims is questioned, the claims are to be interpreted in a way that (1) preserves their validity and (2) provides the broadest reasonable interpretation under the circumstances. A “plurality” means more than one.

Other features and advantages of the invention will be apparent from the following drawings, detailed description, and appended claims.

### BRIEF DESCRIPTION OF THE DRAWINGS

FIG. 1 illustrates a representative basic Scanner head in explosion view

FIG. 2 illustrates a representative basic scanner head painting an Archimedean spiral of coordinate indicative radar bursts.

FIG. 3 illustrates a representative Archimedean spiral

FIGS. 4a, b, c, d, e, and f illustrates a representative example of possible scanner patterns

FIG. 5 illustrates a representative scanning pattern highlighting inherent dead reckoning of a cart traveling through the coordinate indicative radar pattern.

FIG. 6 illustrates a representative quad pattern of synchronized scanners producing an interleaved pattern of coordinate indicative radar.

FIG. 7 illustrates a representative square navigation pattern as produced by gating off certain segments from a radially projected beacon.

FIG. 8 illustrates a representative rectangular navigation pattern as produced by gating off certain segments from a radially projected beacon.

FIG. 9 illustrates a representative Servo controlled galvanometer driven dual axis reflector capable of creating complex X and Y axis patterns.

FIG. 10 illustrates representative millimeter radar pulse transmitter.

FIG. 11 illustrates a representative un-gated single scanner in course grain localization centered in a parking lot.

FIG. 12 illustrates a representative gated single scanner in fine grain localization corner zoned in a parking lot.

FIG. 13 illustrates a representative EM Scanner and dual axis articulated reflector

FIG. 14 illustrates a representative EM Scanner and flat dual axis reflector

FIG. 15 illustrates a representative EM Scanner and octagon dual axis reflector

FIG. 16 illustrates a representative EM Scanner and triangle dual axis reflector

FIG. 17 illustrates a representative EM Scanner and cube dual axis reflector

FIG. 18 illustrates a representative EM Scanner and cube dual axis reflector shown in articulation assembly.

FIG. 19 illustrates a representative cooperative EM transponder receiver block diagram

FIG. 20 illustrates a representative cooperative EM Plotter circuit block diagram

FIG. 21 illustrates a representative cooperative EM transponder functional block diagram

### DETAILED DESCRIPTION

As those in the art will appreciate, the following detailed description describes certain preferred embodiments of the invention in detail, and is thus only representative and does not depict the actual scope of the invention. Before describing the present invention in detail, it is understood that the invention is not limited to the methodologies described, as these may vary. It is also to be understood that the terminology used herein is for the purpose of describing particular embodiments only, and is not intended to limit the scope of the invention defined by the appended claims.

The present invention relates to devices and methods that provide for . . . .

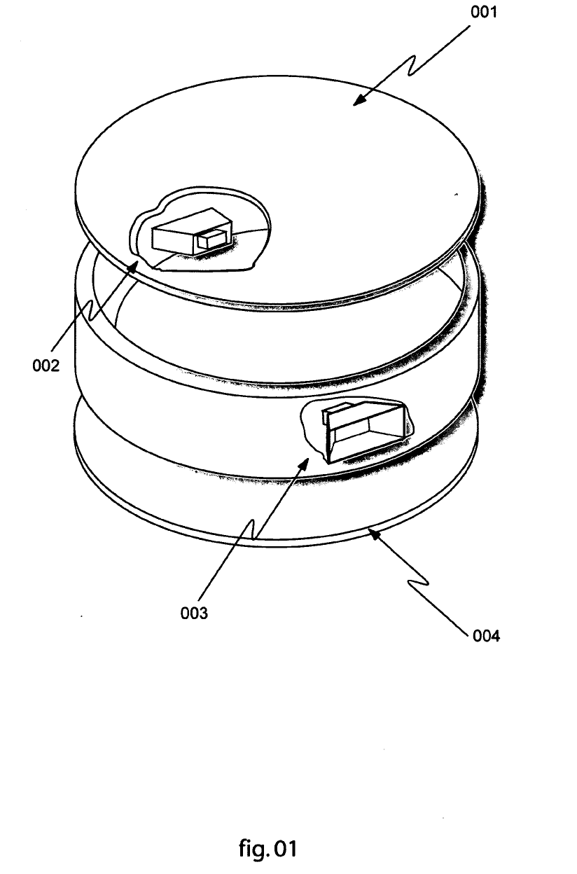

Turning now with reference to the figures, in certain preferred embodiments . . . . . For example, as shown in FIG. 01, a basic explosion view of the navigation and localization system's scanner head that contains the millimeter radar, beam steering mechanism, onboard sensors, other radiators, and the control logic. Power is provided by AC mains, internal battery, and an external solar cell to provide charging during sunlight hours. The cutaway in the upper lid reveals one of two opposing millimeter radar horns 002 and 003. Bottom plate 004 is merely shown for reference. This illustration is intentionally void of detail as many details are under design and validation. One skilled in the art would appreciate that there are considerably more components involved in this device including but not limited to a network communications scheme, one or more circuit boards containing the millimeter wave radar, galvo, beam shaper, I.R. and visible lasers as well as a processor and other support hardware, firmware and software.

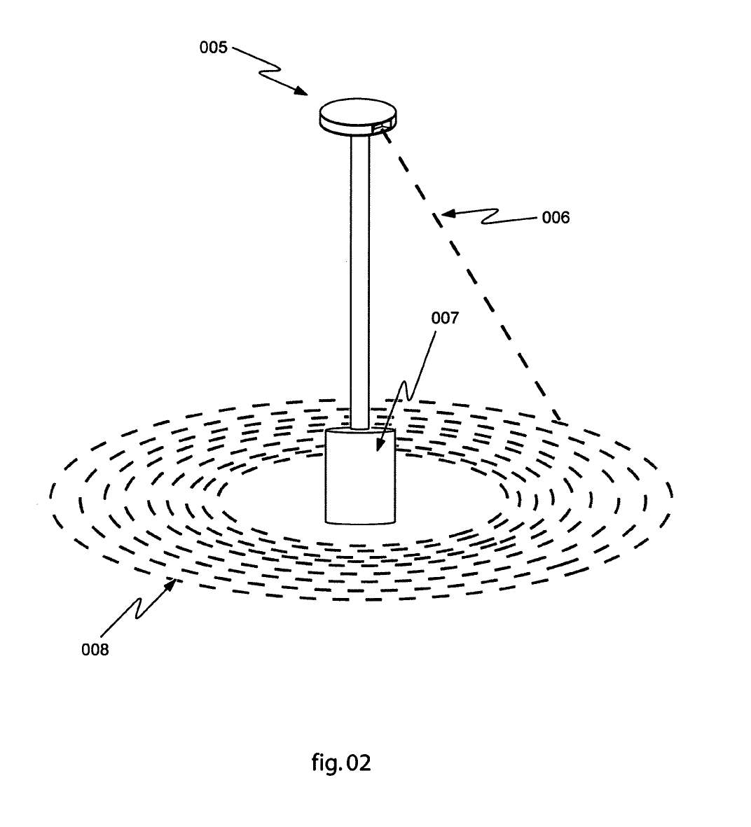

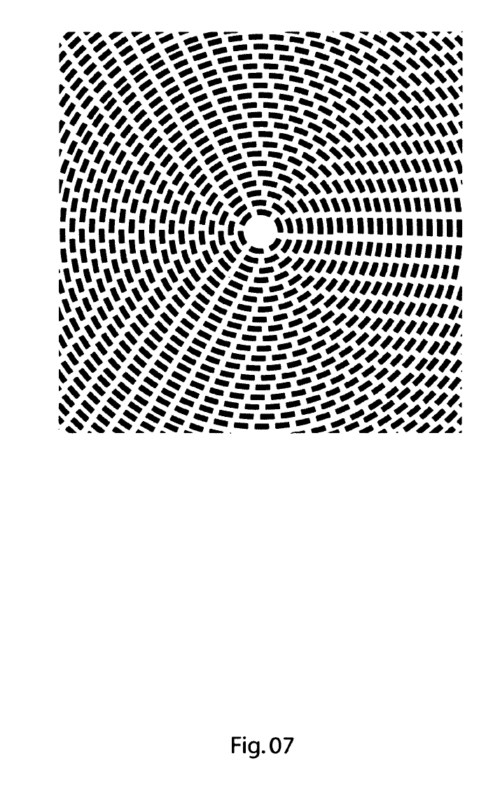

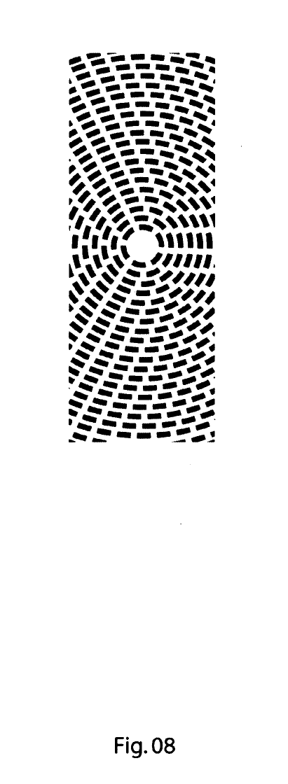

FIG. 02 illustrates a pole mounted 007 millimeter radar scanner 005 producing a single beam 006 Archimedes spirals of coordinate bursts 008. The spiral pattern is shown intact without any segmenting or blanking. The gaps between the radially drawn segments are exaggerated for illustrative purposes. The actual gap duration or spacing may set to any value from zero on depending upon the application. To accommodate the creation of unusual or strategically beneficial shapes the millimeter radar output can be attenuated, gated, focused, defocused or blanked at predetermined times and durations as shown in FIGS. 07 and 08.

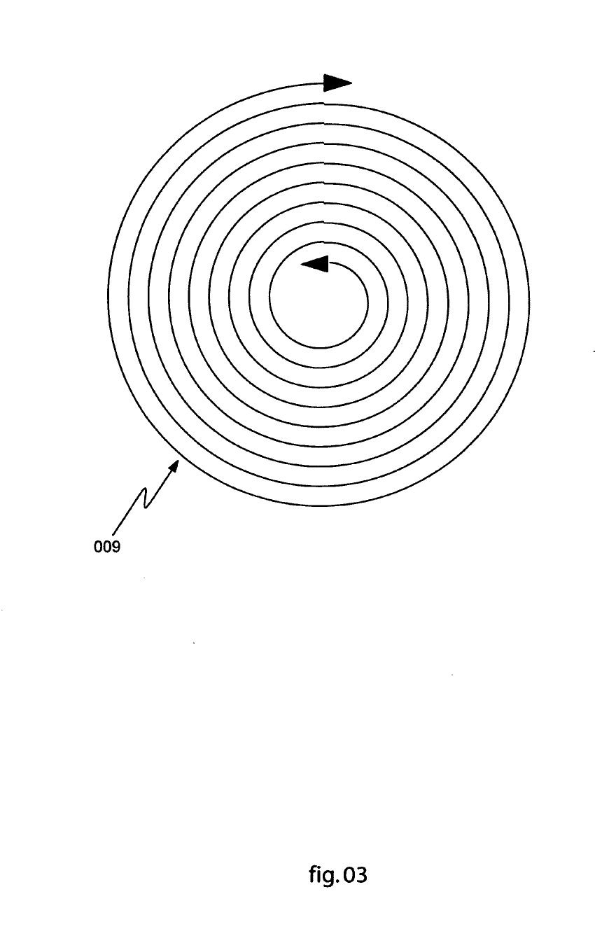

FIG. 03 depicts a top view of an Archimedes spiral 009, the preferred pattern generated in an azimuthally geometric plane. The pattern is created according to the Archimedean equation using an elevation reflector to increase and or decrease the spiral diameter at a predetermined rate of change. This rate of change is directly related to a predetermined resolution or increase of each subsequent spiral diameter.

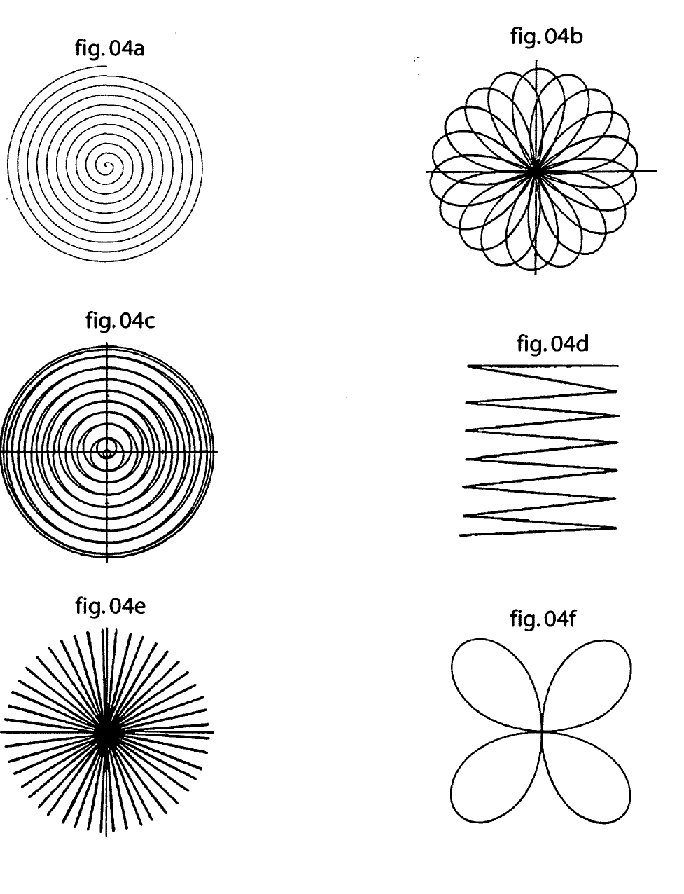

FIG. 04a through FIG. 04f depicts several preferred mm radar navigation plot patterns beginning with the aforementioned Archimedes Spiral a, Rosette b, dual offset spiral c, raster d, rotating line e, and rosette2 f. These patterns are shown as continuous or unbroken line patterns when in fact they could be gated or blanked at any predetermined rate or duration dependant on the needs of each application.

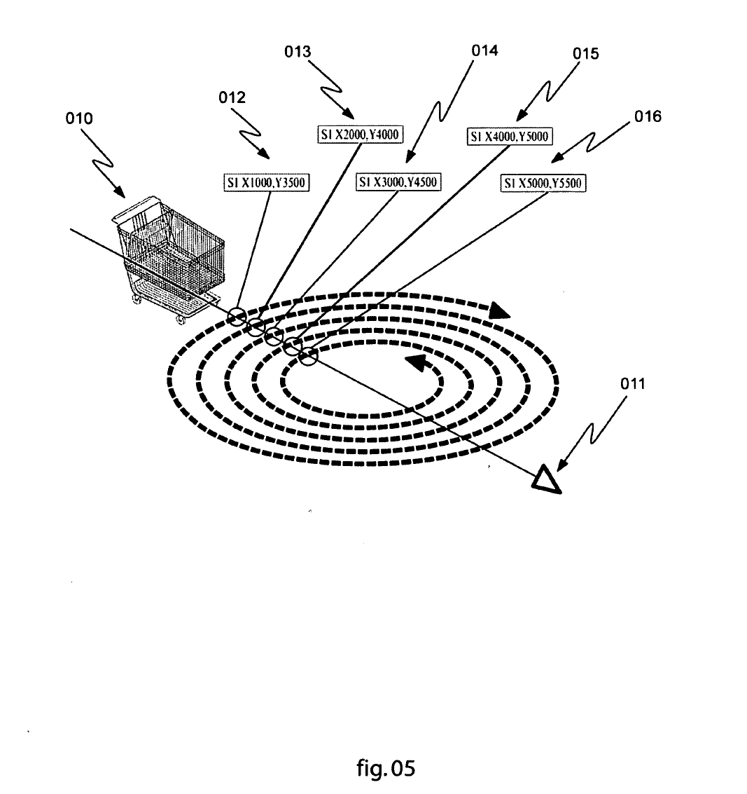

FIG. 05 illustrates the mm radar plotter system's ability to provide inherent dead reckoning data to a transponder or like product imbedded circuit. As depicted a transducer equipped shopping cart 010 is shown entering into the first of several radially generated coordinate data imbedded mm radar navigation zone 012. As the direction of travel line and arrow 011 depicts, the shopping cart will traverse and intersect five navigation pattern rings 013, 014, 015, and 016. Upon the shopping cart's arrival at each pattern ring, the onboard transducer's mm wave radar receiver will detect, decode and store into memory the navigation beacon's coordinate code. Armed only with this one beacon coordinate location 012, the cart is localized at coordinate X1000, Y3500 but until a subsequent beacon coordinate 013 is intersected, the cart is unaware of its heading. Upon arrival at the second navigation beacon ring 013 following the same path as depicted, the onboard transducer's mm wave radar will detect, decode and store into memory the new navigation beacon's coordinate code. Now having detected and decoded a second coordinate 013, the cart now knows its heading simply associating coordinate crossings (012 and 013) to the direction traveled 011. This data is critical in determining when and if the cart needs to be immobilized or not when in proximity to a store entrance or exit or parking lot exit or entrance. If the cart were near an entrance or exit and was determined to be heading off the property as determined by heading data derived from beacon heading data the cart would know by its internal map table that it should immobilize the cart at once. If however the cart were near an entrance or exit and unlike the prior situation was not proceeding with an attempted departure as determined by heading data and navigation as determined by encountering ongoing coordinate updates there would be no reason to secure the cart. To address false or phantom EM pixel reads due to reflections or other forms of multi-path phenomena, Gaussian, kalman, and other forms of filtering could be deployed to provide correction using recent navigation history to normalize the out of norm EM pixel read. EM pixel imbedded coordinate data is derived from a simple trigonometric equation. The known EM beacon elevation angle has to be converted to length by the following formula:

Assumptions:
EM beacon plotter altitude=120 in. (b)
EM beacon angle derived from rotary encoder=35 deg. (a)

Equation:

a=120/tan 35 or 120/0.700208 or 171.38 in.

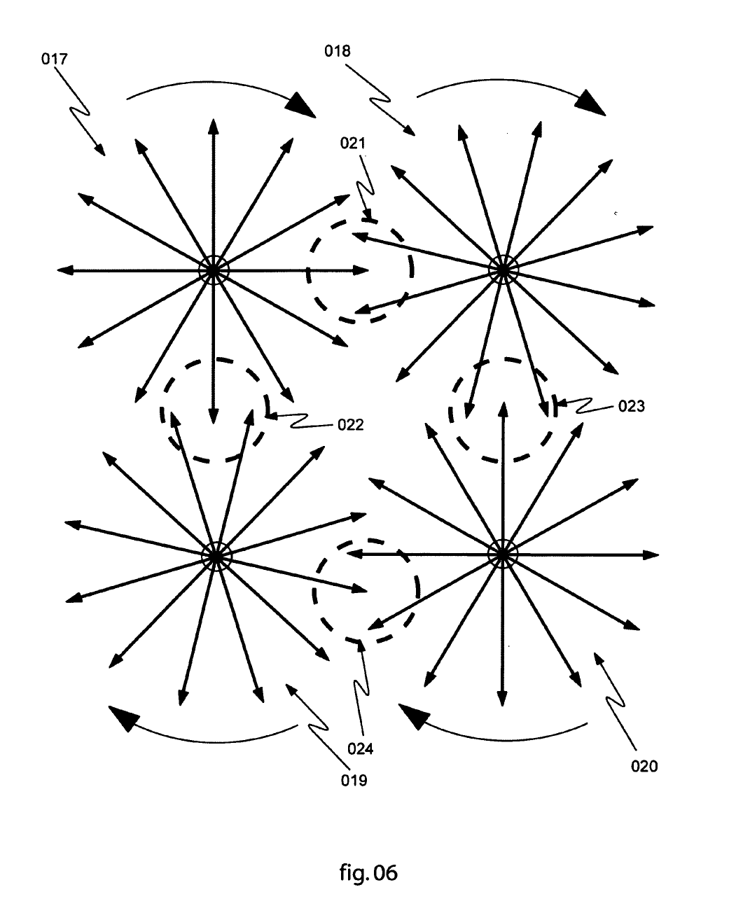

FIG. 06 illustrates the mm radar navigation system's ability to provide synchronized interlaced navigation plotting from two or more plotters. In this embodiment four separate plotters are depicted and so indicated by 017, 018, 019, and 020 respectively. The functional benefit derived from this embodiment is preventing cross modulation interference as a result of two or more adjacent mm wave radar plots arriving simultaneously and is illustrated by 021, 022, 023, and 024 respectively. Such synchronization also allows complex navigation patterns to be constructed by a plurality of radar plotters by blanking overlapping or interfering plot pattern segments.

FIG. 07 illustrates an exemplary mm wave radar navigation pattern in the shape of a square, created by gating off segments from within the radially generated pattern. Gaps in the generated pattern are exaggerated for illustration only. EM pixels consist of very high speed or brief duration data packets. EM pixel density, like conventional ink or laser printers, measured in pixels or “dots” per inch, may be more appropriately measured in “EM pixels” per foot or meter due to scale. Depending upon the application the EM Wave Plotter may be stationary, mobile or handheld and its EM pixel beacons may be directed in any plane. In applications where EM pixel beacons may be attenuated or blocked by pedestrian or vehicle traffic secondary cooperative EM plotters may be positioned to improve coverage.

Mobile versions of the instant invention may use stationary EM Plotters as a means of acquiring its own location coordinates or other means like GPS or improved GPS. As the mobile EM plotter navigates about its course either randomly or by a predetermined pattern its EM pixel beacons update corresponding EM transponders.

FIG. 08 illustrates an exemplary mm wave radar navigation pattern in the shape of a rectangle, created by gating off segments from within the radially generated pattern. Gaps in the generated pattern are exaggerated for illustration only. Since any singular EM pixel or group of EM pixels can be selectively plotted most any conceivable shape can be created.

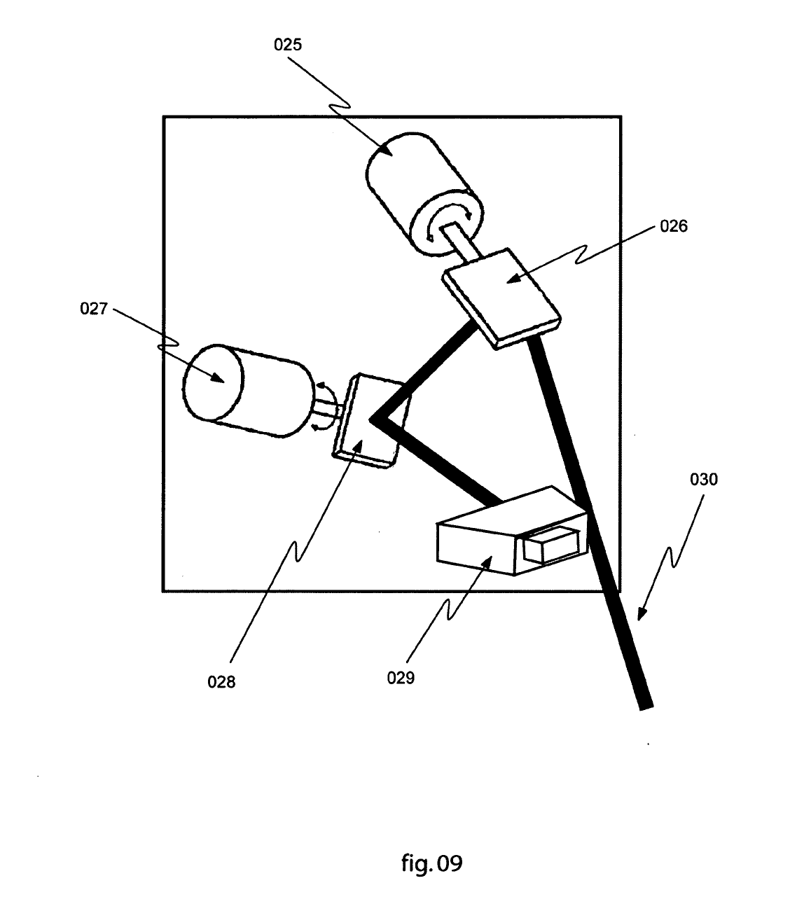

FIG. 09 depicts a simplified X and Y axis galvanometer EM navigation beam director resembling the functionality of a conventional bar code reader. Servo 025 driving reflector 026 provides variable elevation while servo 027 driving reflector 028 provides azimuth scanning of EM source 029 resulting in a fully articulated beacon 030. Real time servo angular speed and position is read by precision optical encoders. This simple illustration depicts only one of any number of beacon beam shaping and articulation methods including radar rotary joints, electronic beam steering, exotic antennas, arrays, and electromagnetic lenses like the Rotman and Luneberg designs.

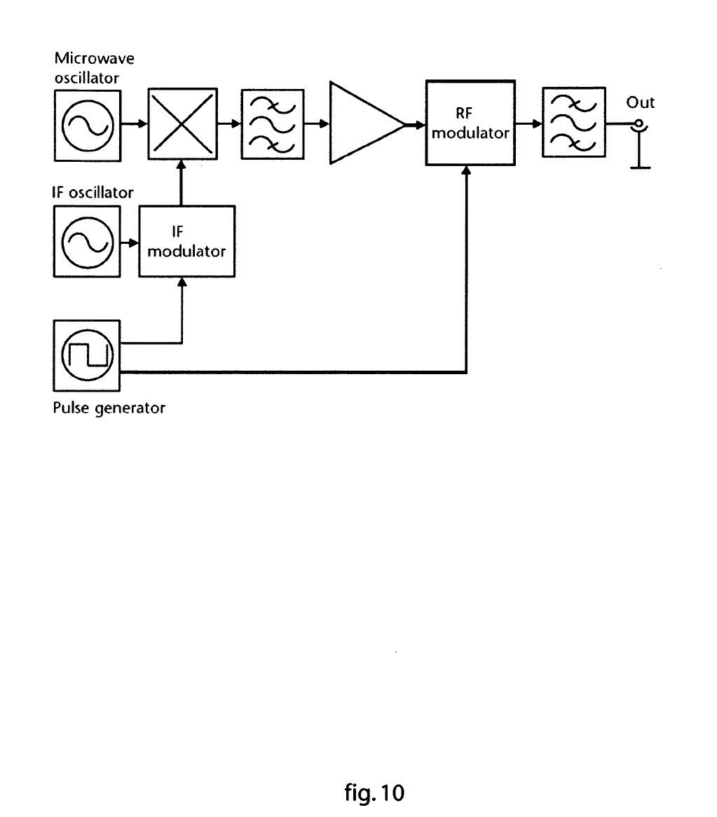

FIG. 10 illustrates conventional pulse modulated mm wave radar. Millimeter wave radar is ideal for the instant invention for two reasons. Operating at such a high frequency permits very high speed data rates which are essential when transmitted from a very high speed spinning radiator assembly. Secondly the size of a half wavelength horn is small and presents a very low mass also essential when contained in a very high speed spinning radiator assembly. The present invention addresses several applications in need of highly resolved Cartesian coordinate localization with a high level of certainty. The spectrum between 30 GHz and 300 GHz is referred to as the millimeter wave band because the wavelengths for these frequencies are about one to ten millimeters. At such a short wavelength or high frequency the millimeter wave band is ideally suited for very high data rates like that needed in a highly resolved high speed navigation topology.

The frequency and distance dependence of the loss between two isotropic antennas is expressed in absolute numbers by the following equation:

L_{FSL}=(4kR/X)²

Free Space Loss where R: distance between transmit and receive antennas;
X: operating wavelength. After converting to units of frequency and in dB, the equation becomes:

L_{FSL dB}=92.4+20 log f+20 log R

where f: frequency in GHz; R: Line-of-Sight range between antennas in km.
The short wavelengths of millimeter wave signals result in low diffraction. Like light waves, the signals are subject more to shadowing and reflection than typical R.F. anomalies.
The localization or tracking of objects, conditions, persons and animals is a difficult task primarily due to limitations presented by the use of stationary fixed angle of view interrogators attempting to detect and transact with transponders that are often obscured to detection by orientation, propagation or other barriers. In asset tracking applications the localization of objects typically involves one or more reader/interrogators detecting the presence of one or more passive or active tags then reporting the event to a network. To provide a high level of resolution of an object multiple reader/interrogators must be deployed in relatively close proximity to create a means of triangulation typically relying upon TOA “Time of flight” or other like schemes. The cost of reader/interrogators is substantial as is the cost of installation.

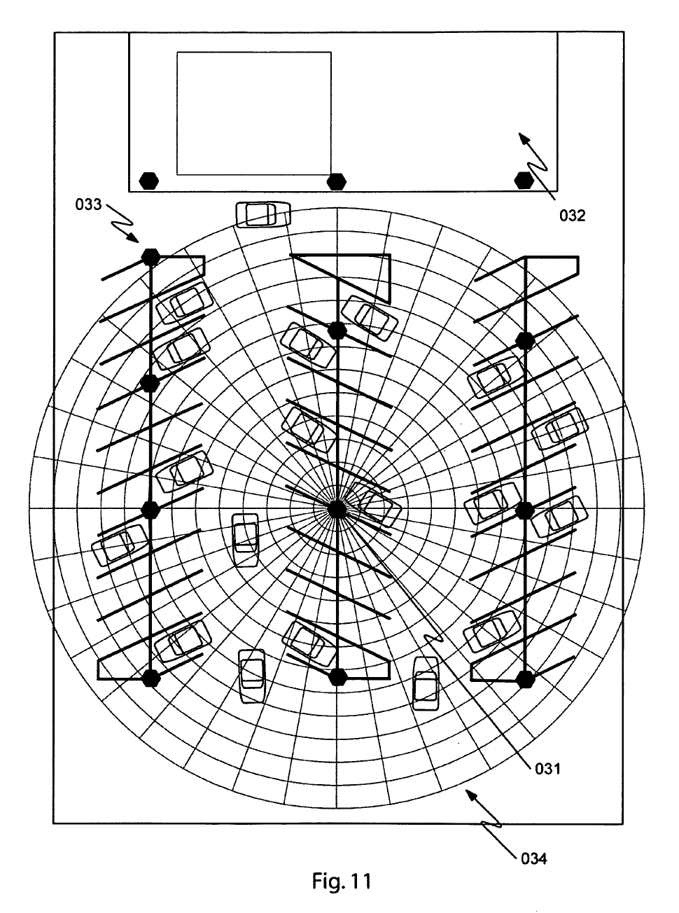

FIG. 11 illustrates a centrally located EM plotter 031 in a typical retail store 032 parking lot 033 producing an uninterrupted or full circumference EM navigation pattern. This particular scenario utilizing only a single EM plotter for an entire parking lot would not be ideal for providing navigation location coordinates to shopping carts due to shadowing or obstruction from vehicle traffic. One or more additional EM plotters strategically located opposite the existing one 031 could provide enough additional coverage to overcome shadowing. In the absence of shadows or obstacles, synchronization between EM plotters prevents EM beacon/pixel collisions when opposing EM beacons overlap each other as illustrated in FIG. 8. In a preferred embodiment of providing navigation coordinates to transponder equipped shopping carts in an outdoor setting, the plotter would likely be mounted or attached to a light pole or rooftop overlooking a parking lot for outdoor applications. In a preferred embodiment of providing navigation coordinates to transponder equipped shopping carts in an indoor setting, the plotter would likely be mounted or attached to a wall or ceiling overlooking a prescribed area of coverage.

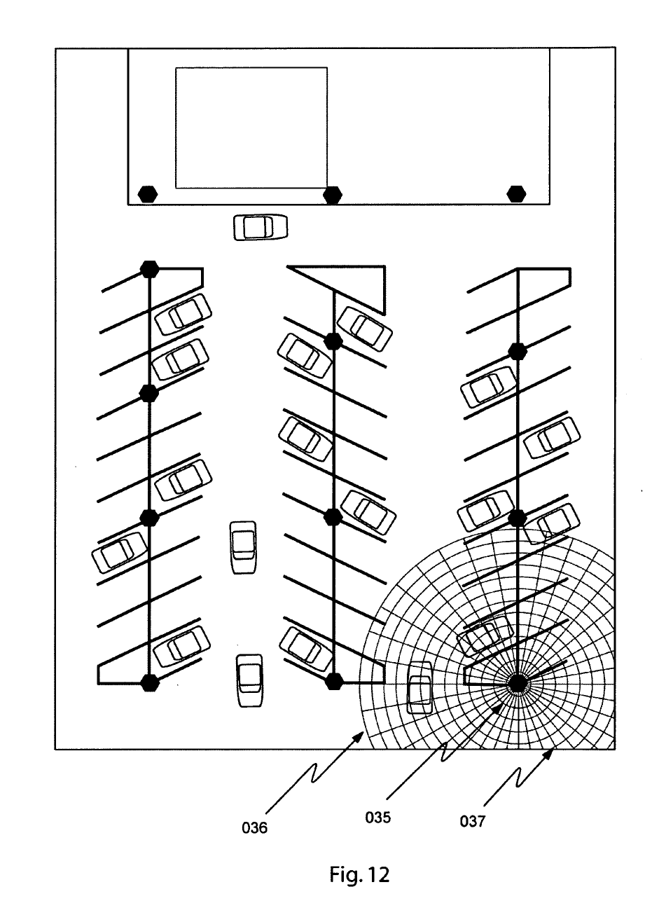

FIG. 12 illustrates a corner of lot positioned EM plotter 035 producing a gated Archimedes spiral pattern 036. To prevent the EM navigation pixels from exceeding the physical parking lot corner boundary 037 the EM plotter produced a gated pattern accordingly. The creation of such a pattern in the EM plotter memory is quite simple using a survey map or by tweaking the shape manually using the calibration mapping tool that activates a visible or I.R. laser that is optically aligned with the EM plotter beacon path. As the EM plotter plots its navigation image a technician could simply calibrate the pattern visually.

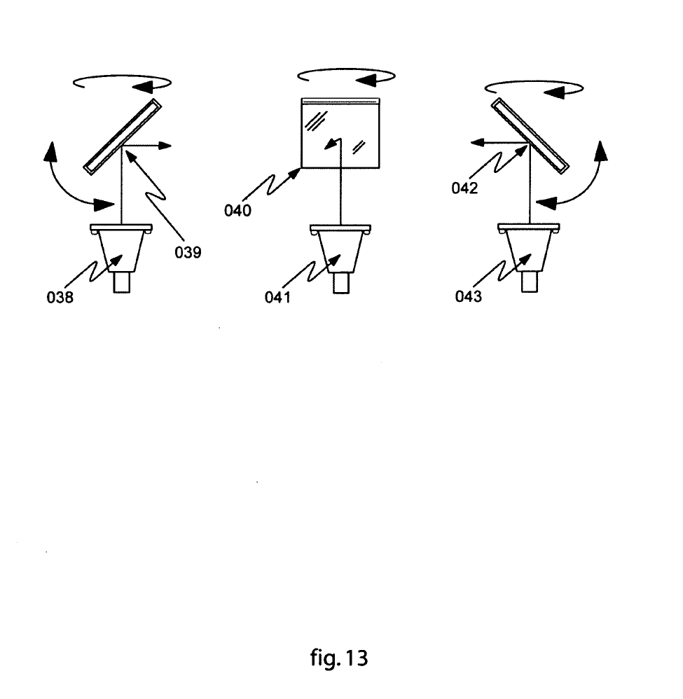

FIG. 13 illustrates basic block diagram of the EM plotter dual axis reflector that redirects the EM radiation from the source which in this case is millimeter wave radar. One preferred embodiment utilizes an upward facing source 038 and a dual axis articulating flat reflector 039 that both rotates 360 degrees about an azimuthal plane and in elevation 360 degrees. All three views of the source and reflector are illustrated in 90 degree rotations from left to right. View 038 and 039 shows a 90 degree source reflection facing right. View 040 and 041 reveals the reflector in a face forward orientation and view 042 and 043 compose a left facing rotation.

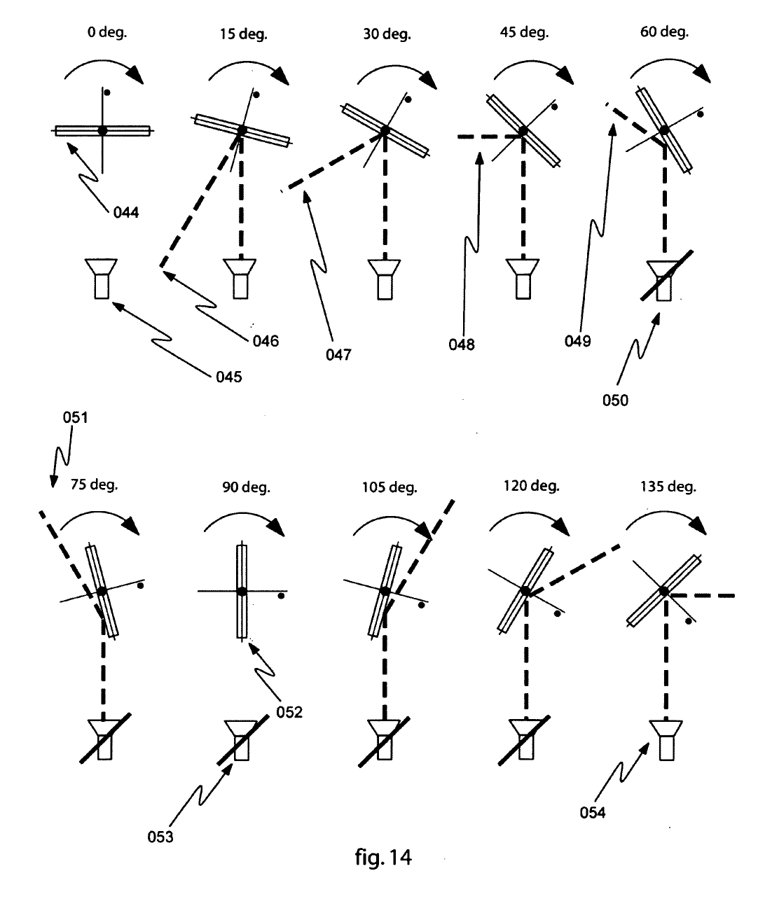

FIG. 14 illustrates a flat planer reflector rotating continuously in a clockwise direction from zero degrees 044 to 135 degrees 054 in 15 degree increments. In most beam directing apparatus designs like barcode readers and other beam pattern generators, an oscillating reflector is deployed. Such technology would not suffice in this type of application due to duty cycle. Considering that the present invention will have to run continuously during business hours and in some embodiments 24 hours a day a reciprocating or oscillation based drive would not be practical. A continuously rotating reflector however is much more robust and immune from mechanical failures. One tradeoff from such an approach is out of range reflection angles as the reflector rotates through unusable reflection angles. This illustration details the resultant angle of reflection “AOR”. In the zero degree position the source to reflector relationship produces no reflection as the incident and reflection angle are equal. As the reflector begins rotating just slightly off center a usable reflected signal is produced. At 15 degrees of rotation 046 it is clear that the reflected signal is producing a downward facing beam that is ideal in most of the preferred embodiments referenced herein like a parking lot navigation system for the localization and securing of shopping carts. 047 depicts a progressively increasing usable angle. It is important to note that while not illustrated in this series of elevation angles that while the EM plotter is rotating the reflector in the elevation plane it is also rotating the same reflector in the azimuth plane resulting in an Archimedean spiral centered about the EM radiator which is preferably disposed in an oblique relation to its corresponding transponders. As the flat reflector continues to rotate another 15 degrees to 45 degrees 048 it has reached its last usable sweep angle as the reflected angle is now at the horizon and can no longer produce a ground level swath of EM data. From 45 degrees on, 049, 051, 052 the reflector remains out of alignment for producing a usable sweep angle until it reaches 135 degrees where the reflected EM angle returns to a usable angle using the back side of the reflector. The slash mark 050 and 053 depicts a usable EM reflection angle.

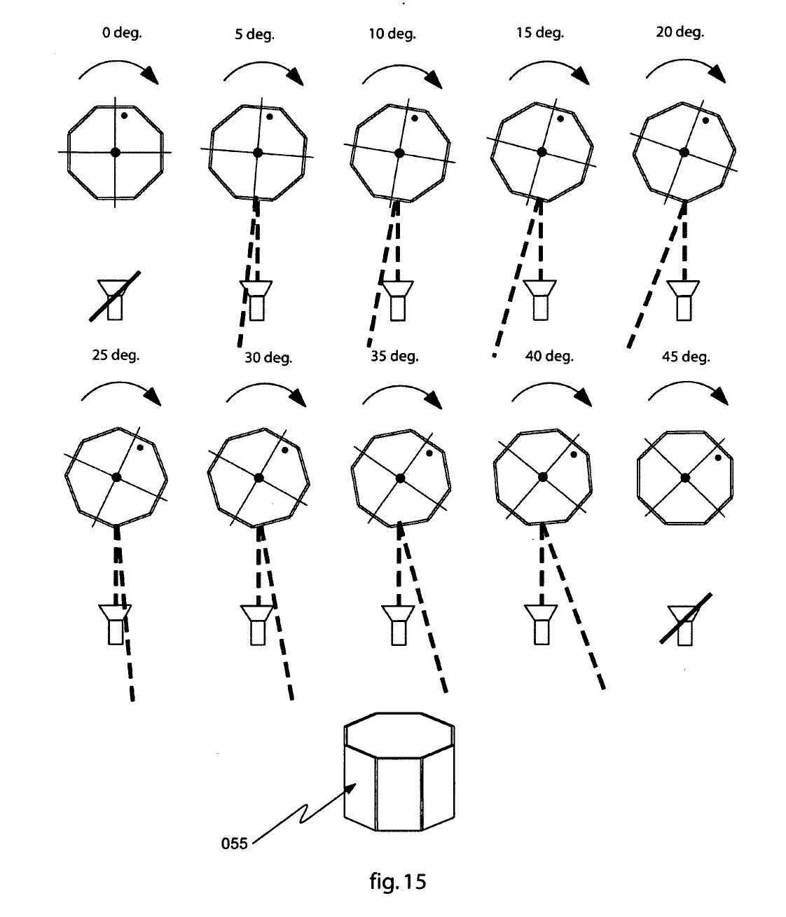

FIG. 15 illustrates an octagonal reflector which produces a zero dead zone pattern at any angle but yields a narrow total cross area.

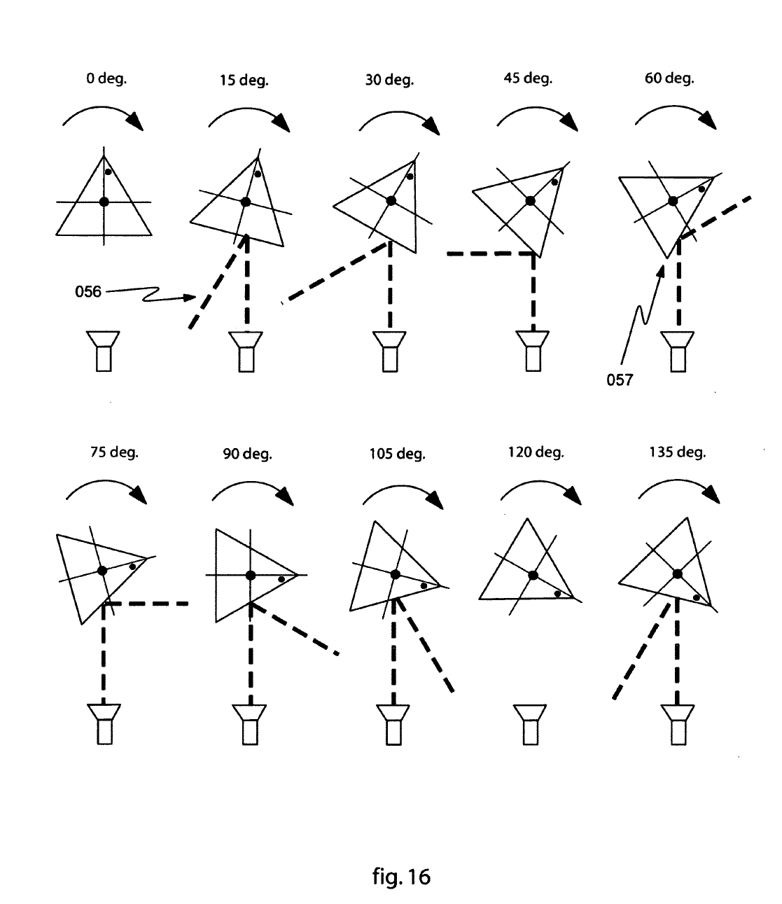

FIG. 16 illustrates a triangular shaped EM reflector that also show promise but would be difficult to manufacture to quality standards. The ideal candidate shape will provide as much usable reflective angle coverage with minimal dead zone area. It has been determined that the ideal usable scan sector is 30 to 35 degrees.

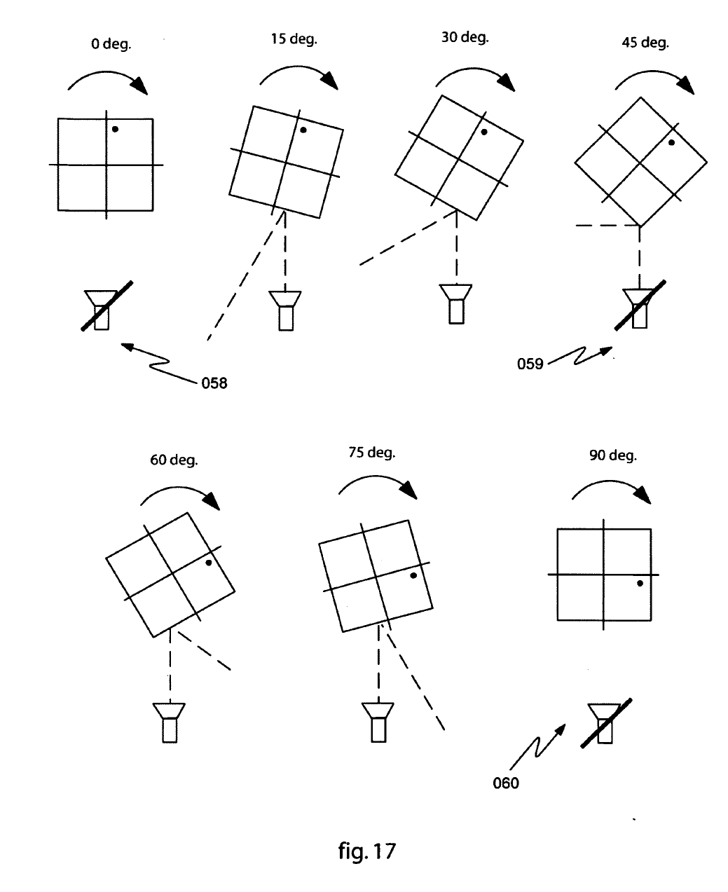

FIG. 17 illustrates a cube shaped EM reflector that appears by modeling as illustrated to be the ideal shape for maximum EM reflection pattern continuity revealing 8 minor single degree EM pattern interruptions at 4 midpoints 058, 060 and 4 corners 059. Since all 8 pattern interruptions occur only during normal incident of the EM beacon there is no interruption of the projected EM beacon that conveys the navigation EM pixels.

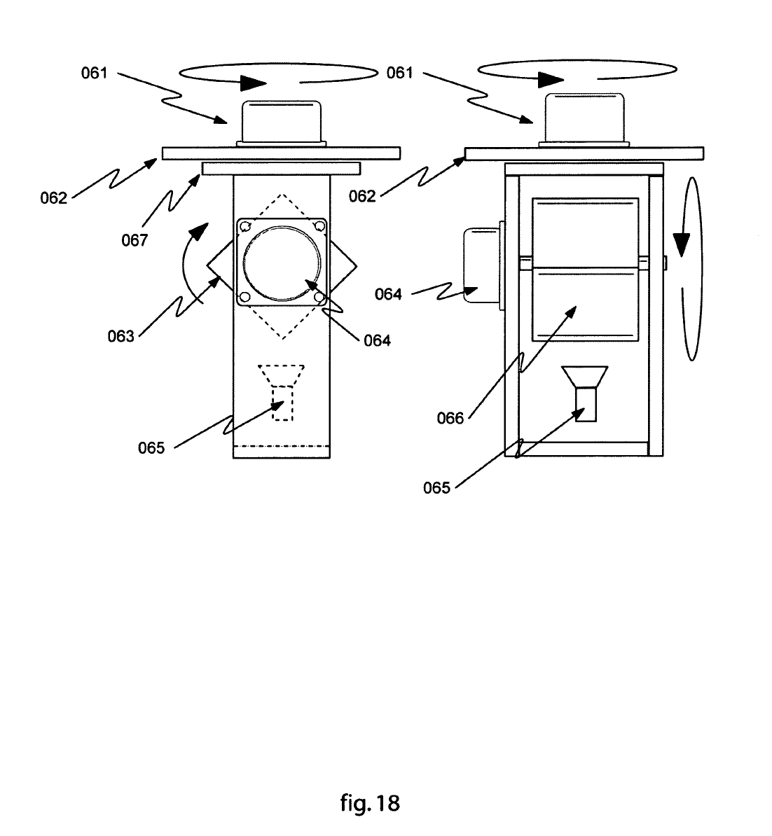

FIG. 18 illustrates a cube shaped EM reflector 063 mounted within a representative dual axis articulator providing rotation of the EM reflector in both azimuth and elevation planes. The EM articulator is first depicted left to right in a side view revealing the azimuth motor 061 and the elevation motor 064. The azimuth motor 061 is mounted to a stationary plate 062 with a connecting shaft passing through the stationary plate attaching to the lower chassis assembly via its corresponding plate 067. The coupling of these two plates 062 and 067 is accomplished by a turntable like bearing to provide smooth and precise rotation repeatability. The EM radiator shown as millimeter wave radar 065 is vertically center mounted with its port facing the reflector. It is likely that a slip ring like coupler may be required to carry power and signal between the stationary 062 and non-stationary 067 sections.

Now referring to the same assembly depicted as being rotated 90 degrees. In this view the cube shaped EM reflector faces forward 066. The FIG. 18 illustration is intended to be merely a simplified example of how such a system could be designed and fabricated and is not representative of the optimal or final configuration. Further reduction to practice will likely present several design iterations that will become clear and included in the non-provisional patent and any subsequent continuations in part.

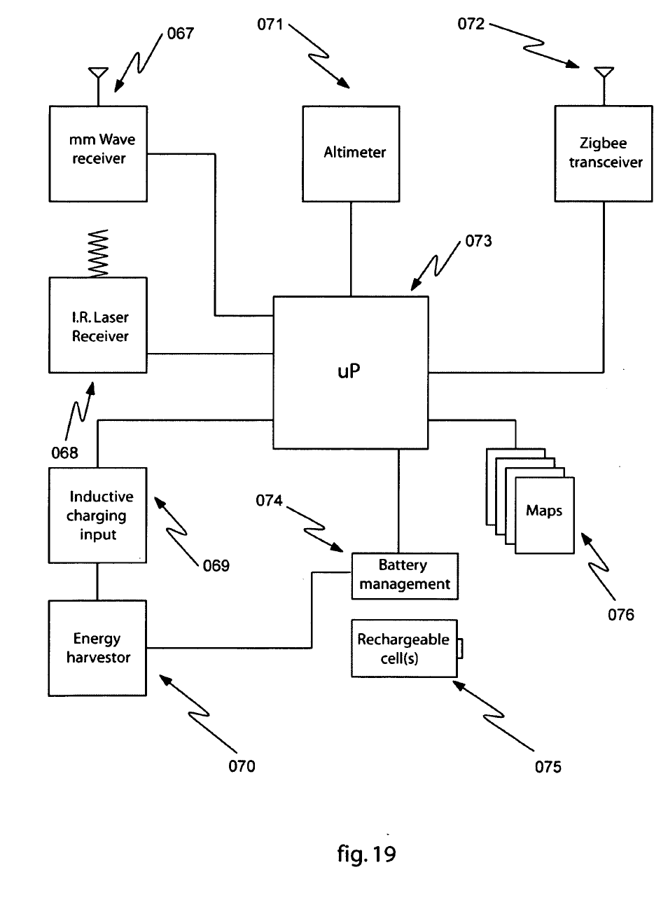

FIG. 19 The cooperative EM transponder in wheel circuit block diagram illustrates an active tag like topology with a processor 074 that manages the system. The system's memory contains maps 077 of its operational environment. Such maps may include parking lots with cart containment boundaries, storage areas, store interiors, store loading docks, restrooms, cafeterias, changing rooms, etc. These maps may be modified, added to, and or deleted by the EM Plotter or via the network during normal operation or on demand globally or individually. The EM plotter system network is based on a low power and low data rate Zigbee 073 platform. As other 802.11 technology becomes more battery friendly the network may adapt accordingly. To keep the battery 076 charge level as near capacity as possible the EM transducer utilizes two forms of in-motion energy harvesting schemes 071 and one inductive charging means 070. The in-motion energy harvesting methods involve the use of Faraday and piezo generated currents both produced by vibration and or mechanically induced forces from wheel rotation. The internal inductive charging coil 070 performs as a split transformer secondary winding and upon placing a geometrically matching primary winding in very near proximity to the secondary coil a charging current is transferred. All sources of power generation is controlled by a battery management circuit that rectifies and regulates charge levels to the battery. The EM transponder is able to determine its own altitude by simply knowing its function. The EM Plotter's navigation patterns are preset for the lowest possible altitude application which would be a shopping cart wheel imbedded transponder circuit which would represent an altitude of approximately 2 inches. An employee tag could vary from hip to shirt collar height which without a survey of average heights of male and female populations is a real loose estimation of say 3 to 5 feet. The Transponder knowing its application by an internal code could just pick an average of 4 feet and know it has to offset its altitude down to 2.5 inches. If such a method proved to be faulty in the reduction to practice of the present invention the EM transponder could fall back on its onboard altimeter 072. The purpose of this device is to provide an altitude offset if the EM transponder is deployed in a mixed use environment where one or more other applications are being served like the mix of shopping cart wheels, employee badges, and delivery vehicles. Such a mix of uses presents a challenge for a system reliant upon known altitudes of both the EM plotter and its corresponding transponders. Slight variations in altitude shopping cart wheels is of little concern but an application variation of shopping carts and employee worn EM badges presents an altitude deviation of up to a few feet. The Receiver 068 detects and decodes the EM plotter beacon navigation data. The EM transponder will report to the network upon the expiration of a predetermined period of time or upon events like navigation coordinates of interest, battery condition, excessive speed or other unsafe condition, and any other detectable notable condition or event.

The I.R. laser receiver 069 provides an additional communication receiver for software updates, “wake on command”, and an alternate EM navigation beacon receiver.

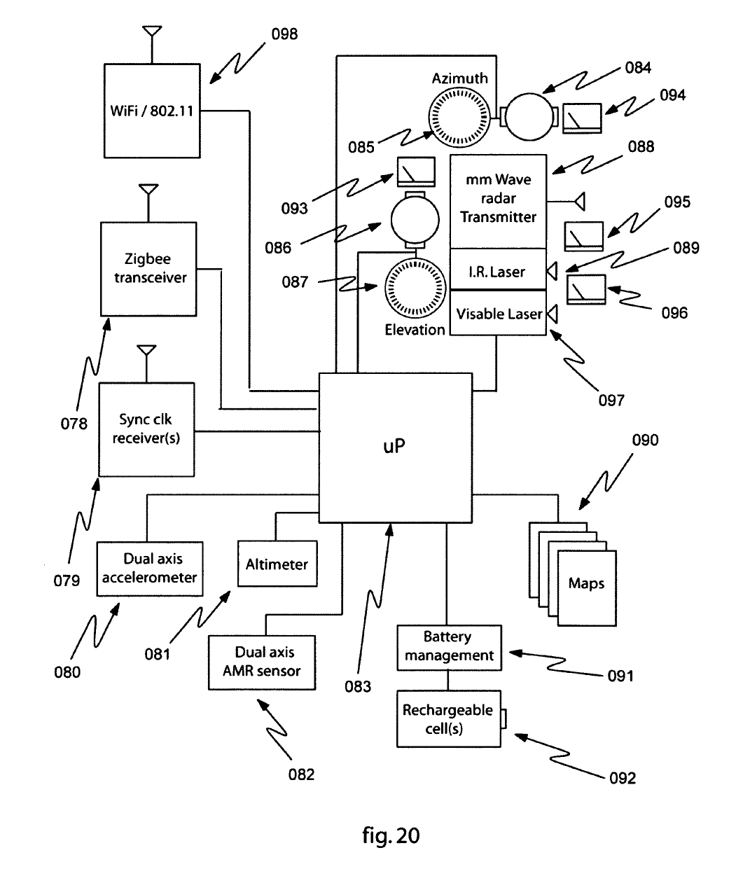

FIG. 20 is a circuit block diagram of the EM plotter beginning with the heart of the present invention, the EM plotter's scanner assembly consisting of azimuth drive motor 084 and its corresponding rotary encoder 085, the elevation motor 086 and its corresponding rotary encoder 087, and the EM beacon generators, mm radar 088, I.R. laser 089 and visible laser 097. Both the azimuth and elevation motors as well as the EM radiators are monitored with sensors. The motors are monitored for current draw 093 and 094 as an indicator of an open circuit winding and a stalled rotor. The motors are also monitored for vibration 093 and 094 to detect mechanical failures like bearing wear. The EM radiators are monitored 095, 096 for normal and legal output levels. In normal operation the motors steer the narrow EM beacon outputs independently or together sharing the same path. The millimeter wave radar beacon is the primary navigation plotter output source followed by the InfraRed laser. Most applications will utilize the radar and some will use just the laser depending on the application. The visible laser 097 is used for visually illuminating the EM beacon path to allow those involved in the installation process to be able to see the otherwise invisible EM navigation patterns and pixels contained therein. This visual aid will allow one to see where multiple EM plotters might be inadvertently overlapping each other or not reaching their intended coverage areas. The microprocessor 083 is shown as a single device but consists of a few processors to handle the high speed scanning rate data and the EM pixel packet data. Navigation maps 090 are managed by one of the processors.

Network communications is handled with a wireless 802.11a/g router 098. The EM plotter system can communicate with an on premises workstation or with the addition of a pcs/gsm cellular phone module can call the factory or local service rep in case of malfunction.

In case of power failure the EM plotter does have a UPS battery 092 managed by a battery management circuit.

The EM plotter's Zigbee transceiver 078 provides the transponder network interface and communications as a stationary node in an ad hoc or mesh network. The network is self healing. To synchronize the EM plotters to a known timing source 079 there are a couple preferred methods. WWB in Fort Collins Colo. broadcasts a GMT clock pulse that is detectable and decodable using inexpensive Low Frequency WWB receiver I.C.s. There is also a precision version of the common GPS system called RTK “Real Time Kinematic” that produces localization accuracies of 2 centimeters. This board may be dockable as to allow different types of clock signals to be optimized to the locality of the system installation. To ensure the EM Plotter is properly oriented and maximally level, an internal dual axis accelerometer 080 is deployed to precisely indicate inclination in reference to gravity. Such sensors are inexpensive and readily available. To determine the EM plotter's own physical relation to true north a MEMS AMR type magnetic sensor 082. Once the EM plotter is set to run after an install it self calibrates it compassing reference to true north thereby establishing a count location on the 085 azimuth motor's rotary encoder 084 as a true north heading count. More specifically the azimuth rotary encoder is a 3600 pulse per revolution device. To calibrate it for compassing it may be rotated at a slow speed like 10 RPM for 10 revolutions. During this calibration process the system's micro-controller is logging the azimuth encoder 084 count upon each full revolution looking for a majority wins or best fit count location that best aligns with the compass data. To auto-calibrate the EM plotter's altitude an altimeter circuit 081 is deployed. The calibration process occurs on power up.

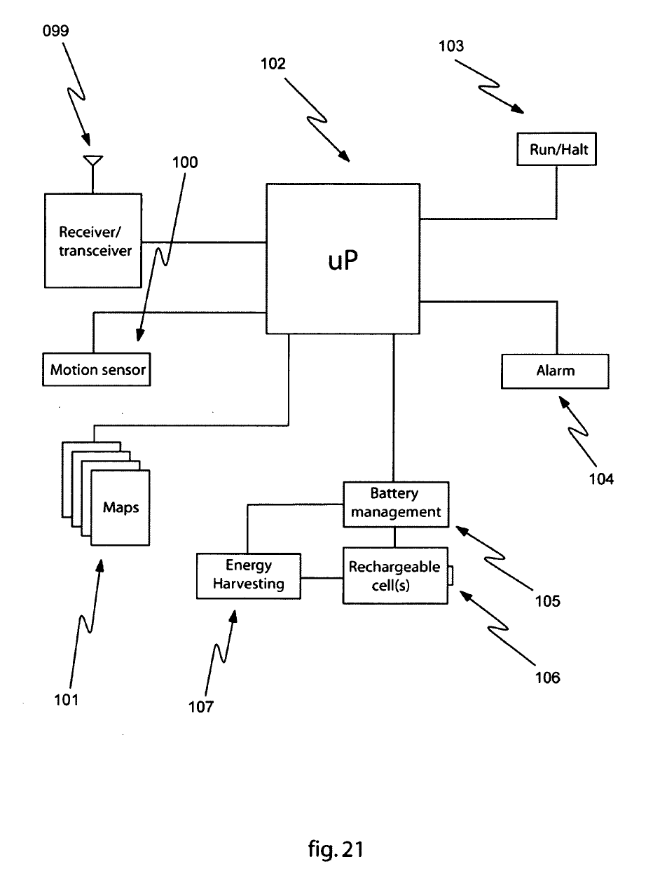

FIG. 21 is a circuit block diagram of the EM Plotter cooperative universal transponder beginning with the receiver/transceiver section 099 that receives and decodes the EM plotter data and when applicable transmit an acknowledgement to one or more EM Plotters or a network such as a low power Zigbee (protected name) or other mesh network. To wake the EM Plotter Transponder from a low current sleep state a motion detector/sensor 100 outputs a signal upon detection of motion. Such a detector would be especially advantageous in applications calling for the monitoring of wheeled objects like shopping carts, golf carts, inventory racks, baby carriages, ride on toy vehicles and any other wheeled technology or toy. Once a wheeled object reached and established perimeter boundary the wheeled object could be disabled by a halt command 103 issued by the microprocessor 102. In order for the EM Plotter transponder to translate the EM Plotter coordinate embedded transmissions it refers to one or more stored digital maps 101 to resolve its location and determines if it is proximate an established operational boundary. These maps also contain coordinates of interest like landmarks. In a grocery store or like enterprise, stored landmarks could be merchandise locations, store entrances, store exits, restrooms and other locations of interest. In a museum the EM Plotter Transponder maps could provide information about exhibits upon detecting proximity to such a point of interest. In the boundary control of canines the EM Plotter Transponder could alarm 104 and enable a mild shock device or vibrator on a corresponding collar worn by the subject canine. The alarm function could also provide and anti-theft functions when attached to an asset worthy of location awareness and audible alarm to warn others of a pending or theft in progress. To augment or replace the EM Plotter Transducer's batteries 106 an energy harvesting means 107 is deployed converting vibration to usable energy using Faraday and or piezoelectric technologies.

What is claimed is:

1. A 360 degree scanning electromagnetic plotter comprising:
one or multi-axis radiators to emit navigation coordinate embedded electromagnetic pixels;
a beam steering means;
a beam focusing means;
a modulator to create EM pixels;
a rotary encoder to provide azimuth measurement;
a rotary encoder to provide elevation measurement;
a digital compass to provide Cartesian coordinates;
a dual axis accelerometer to provide mounting orientation y coordinate offset data;
a microprocessor to calculate and deliver x, y and z coordinate data to the radiator(s);
a network interface to provide wired and wireless communications;
a corresponding transponder to receive EM generated coordinates from plotter;
and one or more receivers to receive broadcasts from a corresponding transponder;
wherein the 360 degree scanning electromagnetic plotter may be physically mounted to a structure or be transportable.

2. The navigation system of claim one, wherein the Electromagnetic plotter produces and emits navigation coordinate embedded pixels much like a conventional ink plotter but using electromagnetic energy based spatially controlled transmissions resulting in electromagnetically detectable electromagnetic pixels in patterns into or onto a predetermined space.

3. The navigation system of claim one, wherein a corresponding electromagnetic signal receiving transponder or like circuit detects and decodes the spatial coordinate location pixels broadcasted by the Electromagnetic plotter.

4. The apparatus of claim 2, further comprising means to create well defined spatial patterns, shapes or images containing coordinate embedded electromagnetic pixels.

5. The apparatus of claim 3, wherein the transponder or like circuit may react to the data contained in the EM pixel or pixels by activating an internal or external device like a display, alarm, transmitter, etc.

6. The apparatus of claim 3, wherein the transponder or like circuit uses internal updateable digital maps or look up tables to translate received or stored EM coordinate embedded pixels.
